(19) United States
(12) Patent Application Publication
(10) Pub. No.: US 2017/0208315 A1
(43) Pub. Date: Jul. 20, 2017

(54) DEVICE AND METHOD OF TRANSMITTING FULL-FRAME IMAGES AND SUB-SAMPLED IMAGES OVER A COMMUNICATION INTERFACE

(71) Applicant: SYMBOL TECHNOLOGIES, LLC, LINCOLNSHIRE, IL (US)

(72) Inventor: Aleksandar Rajak, Ottawa (CA)

(21) Appl. No.: 15/000,660

(22) Filed: Jan. 19, 2016

(51) Int. Cl. H04N 13/00; H04N 13/02

(52) U.S. Cl. CPC H04N 13/0059; H04N 13/0239

(57) ABSTRACT

A device and method of transmitting full-frame images and sub-sampled images over a communication interface are provided. The device comprises: a first camera device and a second camera device; one or more camera communication interfaces in communication with the first camera device and the second camera device; an output communication interface; and, an image streaming processor configured to: receive full-frame images from each of the first camera device and the second camera device using the one or more camera communication interfaces; synchronize the full-frame images in pairs; scale a first subset of the pairs of the full-frame images to produce a set of pairs of sub-scaled images; and, transmit the set of pairs of sub-scaled images and a second subset of the pairs of the full-frame images over the output communication interface, the second subset of the pairs of the full-frame images remaining unscaled.

### BACKGROUND

Dimensioning imaging uses a pair of cameras to capture full-frame stereo image pairs of items to be dimensioned, and the full-frame image pairs are processed to determine dimensions of the items. However, in the mobile device space, data transfer speed is a limitation factor for combining such dimensioning imaging, and/or other types of image analysis, with a live-image preview feature for full-frame images of 1.2 Mpix, or higher, resolutions. For example, a USB (Universal Serial Bus) can be used to transfer images from the cameras to a device for analysis; while a theoretical USB data transfer speed is 480 Mbps, in practice on mobile devices, a maximum achievable data transfer speed is about 200 to 240 Mbps. Hence when the cameras have 1.2 Mpix image sensor, with 12 bit/pix, one full-frame image pair will have a size of 28.8 Mb, which leads to a maximum of 6 fps for full-frame images that could be transferred as image pairs over a USB2 connection. Such data transfer rates are not fast enough for both a live-image preview feature and image analysis. For example a minimum frame rate for a live-image preview feature is 16 fps.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate implementations of concepts described herein, and explain various principles and advantages of those implementations.

FIG. 1 is a schematic block diagram of a device for transmitting full-frame images and sub-sampled images over a communication interface, in accordance with some implementations.

FIG. 2 is a flowchart of a method of transmitting full-frame images and sub-sampled images over a communication interface, in accordance with some implementations.

FIG. 3 depicts the device of FIG. 1 implementing a portion of the method of FIG. 2, in accordance with some implementations.

FIG. 4 depicts the device of FIG. 1 implementing a further portion of the method of FIG. 2, in accordance with some implementations.

FIG. 5 depicts a perspective side view, a perspective rear view and a perspective front view of the device of FIG. 1 interfaced with a host device, in accordance with some implementations.

FIG. 6 depicts a schematic block diagram of the device of FIG. 1 in communication with a host device, in accordance with some implementations.

FIG. 7 is a flowchart of a method of implementing a live-image preview and dimensioning analysis at a host device, in accordance with some implementations.

FIG. 8 is a schematic block diagram of a device configured to transmitting full-frame images and sub-sampled images over a communication interface, in accordance with a specific non-limiting implementation.

FIG. 9 depicts a stream of sub-scaled images and portions of full-frame images transmitted to a host device over the interface of the device of FIG. 8, in accordance with a specific non-limiting implementation.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present specification.

The apparatus and method components have been represented where appropriate by conventional symbols in the drawings, showing only those specific details that are pertinent to understanding the implementations of the present specification so as not to obscure the disclosure with details that will be readily apparent to those of ordinary skill in the art having the benefit of the description herein.

### DETAILED DESCRIPTION

An aspect of the present specification provides a device comprising: a first camera device and a second camera device; one or more camera communication interfaces in communication with the first camera device and the second camera device; an output communication interface; and, an image streaming processor configured to: receive full-frame images from each of the first camera device and the second camera device using the one or more camera communication interfaces; synchronize the full-frame images in pairs; scale a first subset of the pairs of the full-frame images to produce a set of pairs of sub-scaled images; and, transmit the set of pairs of sub-scaled images and a second subset of the pairs of the full-frame images over the output communication interface, the second subset of the pairs of the full-frame images remaining unscaled.

The device can further comprise a memory and the image streaming processor can be further configured to store at least the second subset of the pairs of the full-frame images in the memory prior to transmitting the set of pairs of sub-scaled images and the second subset of the pairs of the full-frame images over the output communication interface.

The device can further comprise an image converter configured to convert the set of pairs of sub-scaled images and the second subset of the pairs of the full-frame images to an output data format prior to transmitting the set of pairs of sub-scaled images and the second subset of the pairs of the full-frame images over the output communication interface.

A bandwidth of the output communication interface can be less than a bandwidth supporting a frame rate corresponding to a live preview of the full-frame images from each of the first camera device and the second camera device. The output communication interface can comprise a Universal Serial Bus interface.

The image streaming processor can be further configured to scale the first subset of the pairs of the full-frame images to produce the set of pairs of sub-scaled images by one or more of reducing a size and reducing a resolution of the first subset of the pairs of the full-frame images.

The image streaming processor can be further configured to transmit the set of pairs of sub-scaled images and the second subset of the pairs of the full-frame images over the output communication interface by interleaving the pairs of sub-scaled images and the second subset of the pairs of the full-frame images.

The image streaming processor can be further configured to transmit the set of pairs of sub-scaled images and the second subset of the pairs of the full-frame images over the output communication interface by: separating each full-frame image in the second subset of the pairs of the full-frame images into sub-portions of a size compatible with a protocol of the output communication interface; and, interleaving the pairs of sub-scaled images with the sub-portions of the second subset of the pairs of the full-frame images in a serial data stream.

Paired full-frame images from each of the first camera device and the second camera device cam comprise stereo images.

The device can further comprise a host device comprising: a respective communication interface, physically and communicatively mated with the output communication interface; a display device; and an image processor configured to: receive the set of pairs of sub-scaled images and the second subset of the pairs of the full-frame images over the respective communication interface, from the output communication interface; render at least a subset of the set of pairs of sub-scaled images at the display device; and, process the second subset of the pairs of the full-frame images to determine dimensions of items represented in the second subset of the pairs of the full-frame images.

Another aspect of the present specification provides a method comprising: at a device comprising: a first camera device and a second camera device; one or more camera communication interfaces in communication with the first camera device and the second camera device; an output communication interface; and, an image streaming processor, receiving, at the image streaming processor, full-frame images from each of the first camera device and the second camera device using the one or more camera communication interfaces; synchronizing, at the image streaming processor, the full-frame images in pairs; scaling, at the image streaming processor, a first subset of the pairs of the full-frame images to produce a set of pairs of sub-scaled images; and, transmitting, using the image streaming processor, the set of pairs of sub-scaled images and a second subset of the pairs of the full-frame images over the output communication interface, the second subset of the pairs of the full-frame images remaining unscaled.

The device can further comprise a memory, and method can further comprise storing, using image streaming processor, at least the second subset of the pairs of the full-frame images in the memory prior to transmitting the set of pairs of sub-scaled images and the second subset of the pairs of the full-frame images over the output communication interface.

The device can further comprise an image converter, and the method can further comprise converting, using the image converter, the set of pairs of sub-scaled images and the second subset of the pairs of the full-frame images to an output data format prior to transmitting the set of pairs of sub-scaled images and the second subset of the pairs of the full-frame images over the output communication interface.

A bandwidth of the output communication interface can be less than a bandwidth supporting a frame rate corresponding to a live preview of the full-frame images from each of the first camera device and the second camera device. The output communication interface can comprise one or more of a limited bandwidth output communication interface and a Universal Serial Bus interface.

The method can further comprise scaling, using the image streaming processor, the first subset of the pairs of the full-frame images to produce the set of pairs of sub-scaled images by one or more of reducing a size and reducing a resolution of the first subset of the pairs of the full-frame images.

The method can further comprise transmitting, using the image streaming processor, the set of pairs of sub-scaled images and the second subset of the pairs of the full-frame images over the output communication interface by interleaving the pairs of sub-scaled images and the second subset of the pairs of the full-frame images.

The method can further comprise transmitting, using the image streaming processor, the set of pairs of sub-scaled images and the second subset of the pairs of the full-frame images over the output communication interface by: separating each full-frame image in the second subset of the pairs of the full-frame images into sub-portions of a size compatible with a protocol of the output communication interface; and, interleaving the pairs of sub-scaled images with the sub-portions of the second subset of the pairs of the full-frame images in a serial data stream.

Paired full-frame images from each of the first camera device and the second camera device can comprise stereo images.

The device can further comprise a host device comprising: a respective communication interface, physically and communicatively mated with the output communication interface; a display device; and an image processor, and the method can further comprise: receiving, at the image processor, the set of pairs of sub-scaled images and the second subset of the pairs of the full-frame images over the respective communication interface, from the output communication interface; rendering, at the image processor, at least a subset of the set of pairs of sub-scaled images at the display device; and, processing, at the image processor, the second subset of the pairs of the full-frame images to determine dimensions of items represented in the second subset of the pairs of the full-frame images.

Another aspect of the present specification provides a computer-readable medium storing a computer program, wherein execution of the computer program is for: at a device comprising: a first camera device and a second camera device; one or more camera communication interfaces in communication with the first camera device and the second camera device; an output communication interface; and, an image streaming processor, receiving, at the image streaming processor, full-frame images from each of the first camera device and the second camera device using the one or more camera communication interfaces; synchronizing, at the image streaming processor, the full-frame images in pairs; scaling, at the image streaming processor, a first subset of the pairs of the full-frame images to produce a set of pairs of sub-scaled images; and, transmitting, using the image streaming processor, the set of pairs of sub-scaled images and a second subset of the pairs of the full-frame images over the output communication interface, the second subset of the pairs of the full-frame images remaining unscaled. The computer-readable medium can comprise a non-transitory computer-readable medium.

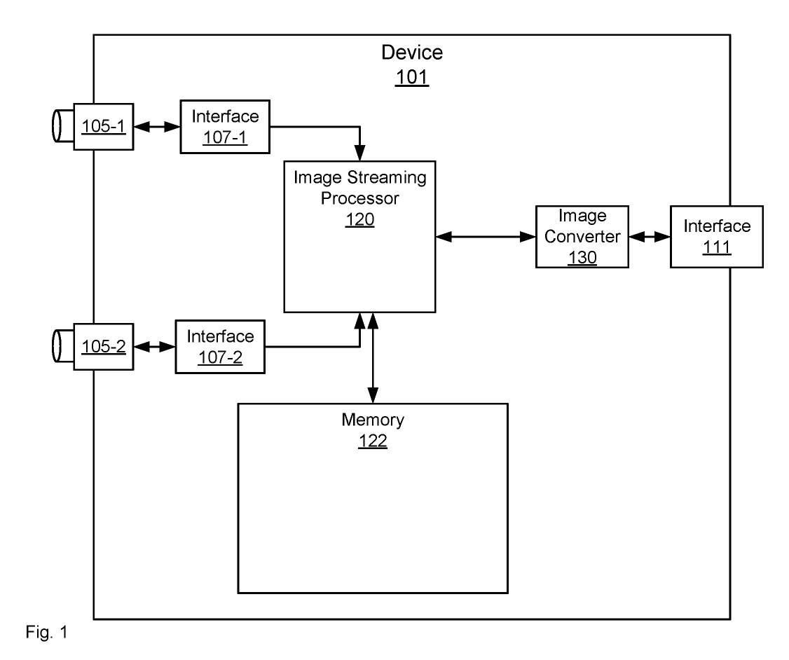

FIG. 1 is a block diagram of a device 101 comprising: a first camera device 105-1 and a second camera device 105-2; one or more camera communication interfaces 107-1, 107-2 in communication with first camera device 105-1 and second camera device 105-2; an output communication interface 111; and, an image streaming processor 120 configured to: receive full-frame images from each of first camera device 105-1 and second camera device 105-2 using one or more camera communication interfaces 107-1, 107-2; synchronize the full-frame images in pairs; scale a first subset of the pairs of the full-frame images to produce a set of pairs of sub-scaled images; and, transmit the set of pairs of sub-scaled images and a second subset of the pairs of the full-frame images over output communication interface 111, the second subset of the pairs of the full-frame images remaining unscaled. As used herein the term “subset” refers to a subset of a plurality of images; whereas, as used herein, the term “portion” refers to a portion of one image, unless specifically defined otherwise.

Camera devices 105-1, 105-2 will be interchangeably referred to hereafter, collectively, as cameras 105, and generically as a camera 105. Similarly, one or more camera communication interfaces 107-1, 107-2 will be interchangeably referred to hereafter, collectively, as interfaces 107, and generically as an interface 107. Output communication interface 111 will be interchangeably referred to hereafter as interface 111.

While two interfaces 107 are depicted, in some implementations, device 101 comprises one interface 107 which is in communication with both cameras 105. Furthermore, while one or more interfaces 107 are depicted as separate from image streaming processor 120, in other implementations, one or more interfaces 107 can be integrated with image streaming processor 120.

As depicted, device 101 further comprises a memory 122, and image streaming processor 120 can be further configured to store at least the second subset of the pairs of the full-frame images in memory 122 prior to transmitting the set of pairs of sub-scaled images and the second subset of the pairs of the full-frame images over output communication interface 111, as described in further detail below.

As depicted, device 101 further comprises an optional image converter 130 configured to convert the set of pairs of sub-scaled images and the second subset of the pairs of the full-frame images to an output data format prior to transmitting the set of pairs of sub-scaled images and the second subset of the pairs of the full-frame images over output communication interface 111.

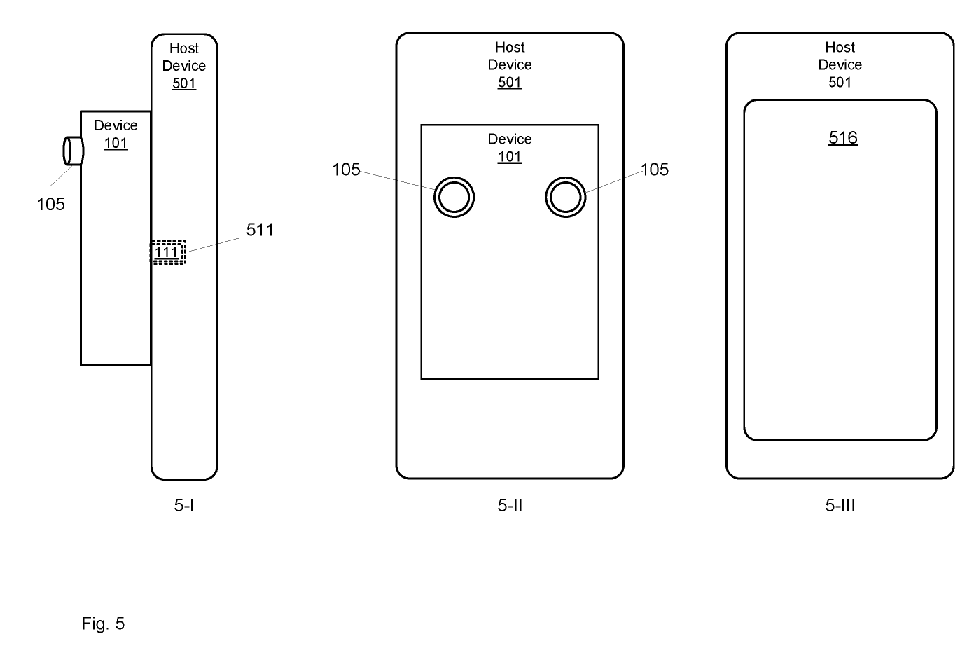

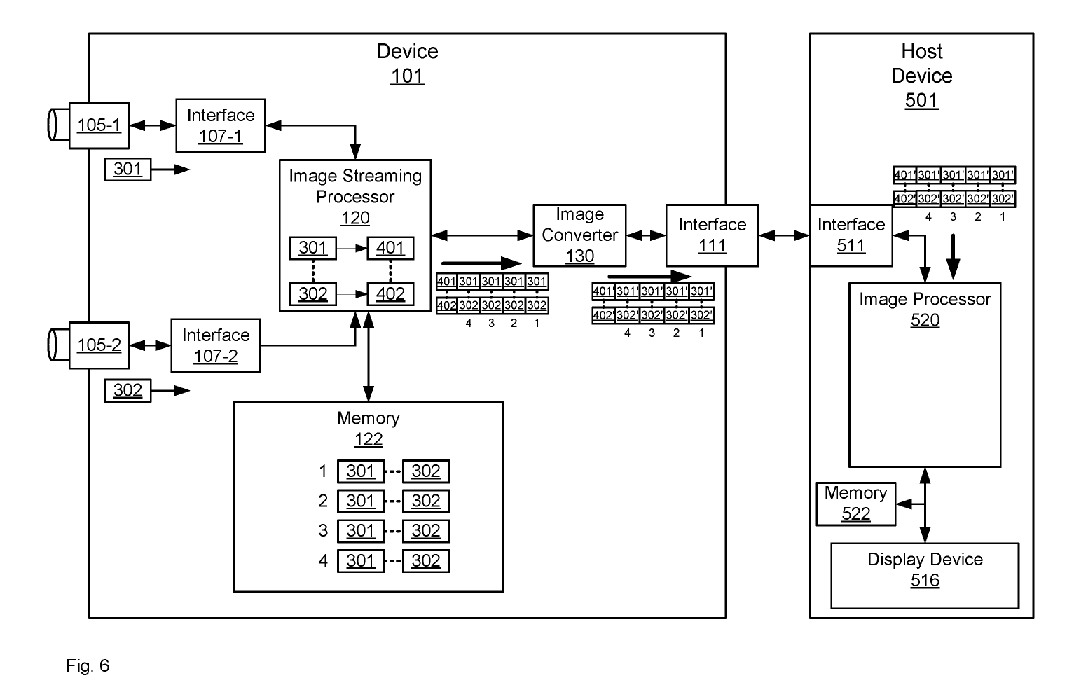

In particular, interface 111 can comprise a limited bandwidth output communication interface including, but not limited to, a Universal Serial Bus (USB) interface, a USB2 interface, a USB3 interface, and the like. It is hence assumed that bandwidth of interface 111 is limited such that a frame rate of full-frame images from cameras 105 over interface 111 is not large enough to provide a live-image preview at a host device (e.g. see FIGS. 5 and 6). In other words, a bandwidth of output communication interface 111 can be less than a bandwidth supporting a frame rate corresponding to a live preview of the full-frame images from each of first camera device 105-1 and second camera device 105-2.

Furthermore, cameras 105 generally image items in a field of view of cameras 105, and the images can be provided, in pairs, over interface 111 to the host device. It is assumed in the present specification that the host device comprises a display device, and that the host device can provide a live-image preview of items in the field of view of cameras 105 by rendering images from cameras 105 at the display device, assuming that the images can be provided to the host device at a rate compatible with live-image preview functionality. However, as interface 111 generally has limited bandwidth, the rate at which full-frame images can be provided to the host device is not high enough to provide a live-image preview. It is further assumed that the host device can process the images to, for example, dimension the items in the field of view of cameras 105; such image processing generally relies on full-frame images in order to extract sufficient data therefrom to analyze and/or dimension the items.

Device 101 addresses this problem by scaling (e.g. reducing in size) a first subset of pairs of full-frame images to produce a set of pairs of sub-scaled images, and transmitting the set of pairs of sub-scaled images and a second subset of the pairs of the full-frame images over interface 111; the second subset of the pairs of the full-frame images are not scaled. Hence, the host device can use the sub-scaled images for a live-image preview and the full-frame images for analysis.

Device 101, and its components, will now be described in further detail.

Device 101 can comprise a computing device, including but not limited to a graphics processing unit (GPU), a graphics processing device, a graphics processing engine, a video processing device, and the like. In particular, device 101 can comprise an apparatus that can be interfaced and/or mated with a host device, and the like, using interface 111, to convert the host device into a live-image preview and image analysis device, as described in further detail below.

Each of cameras 105 can comprise a respective digital camera and configured to acquire respective digital images, including, but not limited to, images in a video stream. While details of cameras 105 are not depicted, it is assumed that each of cameras 105 comprises components for acquiring respective digital images including, but not limited to, respective charge coupled devices (CCD) and the like, as well as respective lenses, respective focusing devices (including, but not limited to voice coils and the like), etc. In particular, lenses of cameras 105 can be separated by a given distance such images from cameras 105 comprise stereo images and hence items being imaged by cameras 105 can be provided to interface 111 in stereo pairs (e.g. as paired left and right full-frame images).

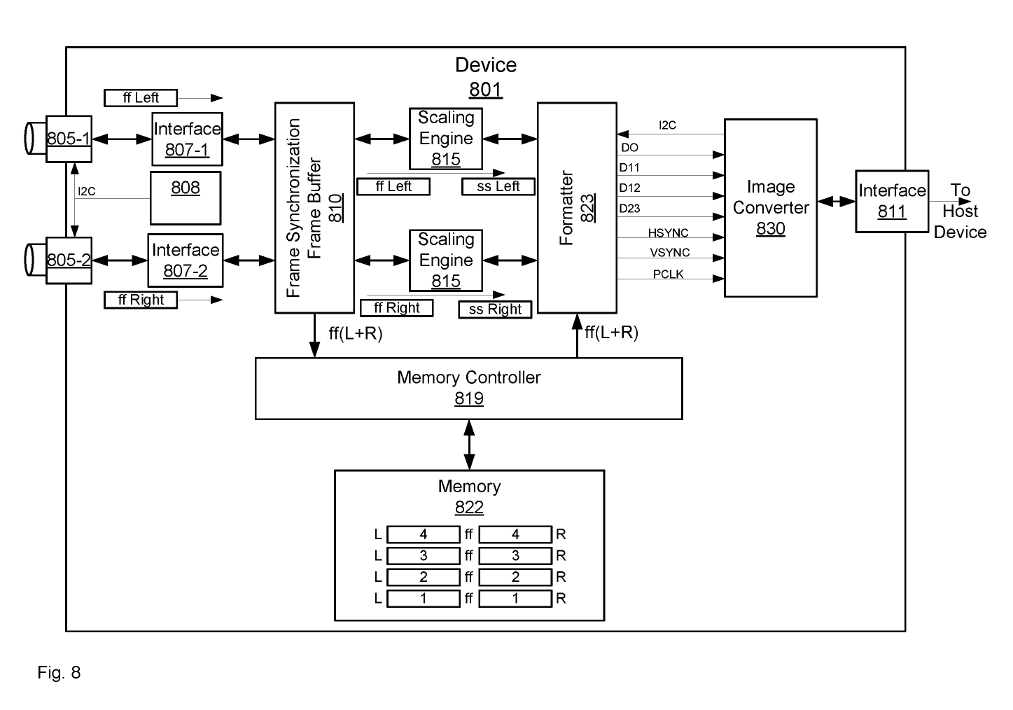

Each of interfaces 107 can comprise any suitable camera interface including, but not limited to, a HiSpi (high-speed pixel interface) interface, a MIPI (Mobile Industry Processor Interface), and the like; in general, each of interfaces 107 can control exposure times of cameras 105, perform limited image analysis to control such exposure times, focus cameras 105, and perform other functions related to controlling cameras 105. However, in some implementations, such control functionality can reside at an IS2 interface to cameras 105 (not depicted, however see FIG. 8).

Image streaming processor 120 can comprise a processor and/or a plurality of processors, including but not limited to one or more central processors (CPUs) and/or one or more processing units and/or one or more graphic processing units (GPUs); either way, image streaming processor 120 comprises a hardware element and/or a hardware processor. Indeed, in some implementations, image streaming processor 120 can comprise an ASIC (application-specific integrated circuit) and/or an FPGA (field-programmable gate array) specifically configured to implement the functionality of device 101. Hence, device 101 is not necessarily a generic computing device, but a device specifically configured to implement specific functionality including sub-scaling a subset of full-frame images from cameras 105 as described in further detail below. For example, device 101 and/or image streaming processor 120 can specifically comprise an engine configured to stream images to a host device for both live-image preview functionality and image analysis.

Memory 122 can comprise a non-volatile storage unit (e.g. Erasable Electronic Programmable Read Only Memory (“EEPROM”), Flash Memory) and a volatile storage unit (e.g. random access memory (“RAM”)). Programming instructions that implement the functional teachings of device 101 as described herein are typically maintained, persistently, in memory 122 and used by image streaming processor 120 which makes appropriate utilization of volatile storage during the execution of such programming instructions. Those skilled in the art recognize that memory 122 is an example of computer readable media that can store programming instructions executable on image streaming processor 120. Furthermore, memory 122 is also an example of a memory unit and/or memory module and/or a non-volatile memory.

In particular, memory 122 can store an application (not depicted) that, when implemented by image streaming processor 120, enables image streaming processor 120 to: receive full-frame images from each of first camera device 105-1 and second camera device 105-2 using one or more camera communication interfaces 107-1, 107-2; synchronize the full-frame images in pairs; scale a first subset of the pairs of the full-frame images to produce a set of pairs of sub-scaled images; and, transmit the set of pairs of sub-scaled images and a second subset of the pairs of the full-frame images over output communication interface 111, the second subset of the pairs of the full-frame images remaining unscaled.

In some implementations, memory 122 can comprise a memory suitable for caching and/or buffering full-frame video and/or full-frame images, including, but not limited to, one or more of DDR (double data rate) memory, DDR2 memory, DDR3 memory, LPDDR (low power double data rate) memory, LPDDR2 memory and the like. Hence, in these implementations, image streaming processor 120 is further configured to store at least the second subset of the pairs of the full-frame images in memory 122 prior to transmitting the set of pairs of sub-scaled images and the second subset of the pairs of the full-frame images over output communication interface 111. For example, the second subset of the pairs of the full-frame images can be stored in memory 122 while the set of pairs of sub-scaled images are being produced.

Furthermore, while not depicted, image streaming processor 120 and/or memory 122 can comprise one or more of an image cache, a frame buffer, a frame synchronization buffer, a frame synchronization frame buffer, a memory controller for controlling and/or determining images and/or frames stored in memory 122 and/or a cache and/or a frame synchronization buffer, and the like.

Image streaming processor 120 can further comprise one or more scaling engines and/or scaling processors (e.g. see FIG. 8) configured to scale a first subset of pairs of the full-frame images from cameras 105 to produce a set of pairs of sub-scaled images. For example, image streaming processor 120 and/or one or more scaling engines and/or scaling processors can be configured to reduce a size of a first subset of pairs of the full-frame images from cameras 105, as described in further detail below.

Image streaming processor 120 can further comprise a formatting engine and/or formatting processors configured to combine the set of pairs of sub-scaled images and a second subset of the pairs of the full-frame images from cameras 105, the second subset of the pairs of the full-frame images remaining unscaled, for transmission over interface 111.

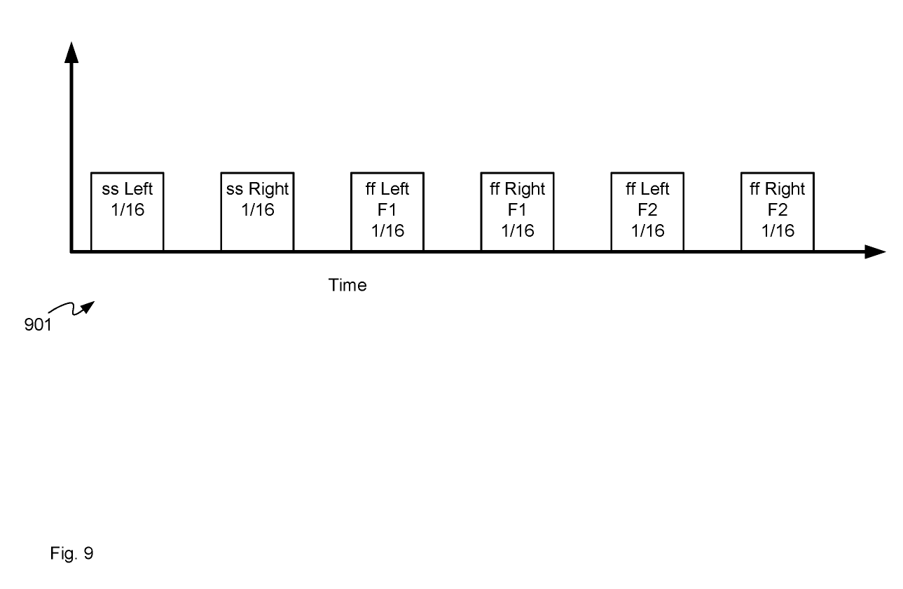

Indeed, specific non-limiting implementations of device 101 are described in further detail below with regard to FIGS. 8 and 9.

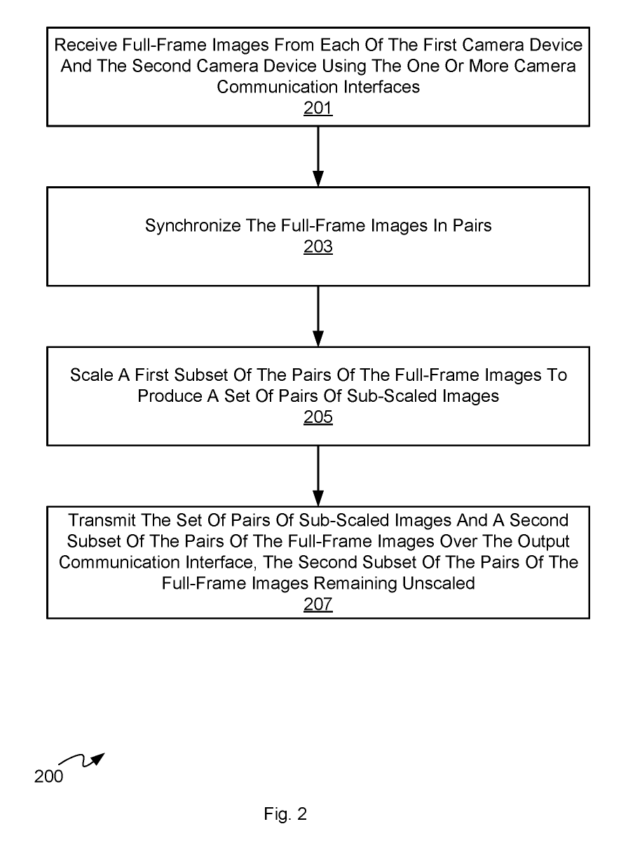

Attention is now directed to FIG. 2 which depicts a block diagram of a flowchart of a method 200 for transmitting full-frame images and sub-sampled images over a communication interface, according to non-limiting implementations. In order to assist in the explanation of method 200, it will be assumed that method 200 is performed using device 101, and specifically by image streaming processor 120 and when image streaming processor 120 processes instructions stored at memory 122. Indeed, method 200 is one way in which device 101 can be configured. Furthermore, the following discussion of method 200 will lead to a further understanding of device 101, and its various components. However, it is to be understood that device 101 and/or method 200 can be varied, and need not work exactly as discussed herein in conjunction with each other, and that such variations are within the scope of present implementations.

Regardless, it is to be emphasized, that method 200 need not be performed in the exact sequence as shown, unless otherwise indicated; and likewise various blocks may be performed in parallel rather than in sequence; hence the elements of method 200 are referred to herein as “blocks” rather than “steps”. It is also to be understood, however, that method 200 can be implemented on variations of device 101 as well.

At block 201, image streaming processor 120 receives full-frame images from each of first camera device 105-1 and second camera device 105-2 using one or more camera communication interfaces 107.

At block 203, image streaming processor 120 synchronizes the full-frame images in pairs,

At block 205, image streaming processor 120 scales a first subset of the pairs of the full-frame images to produce a set of pairs of sub-scaled images.

At block 205, image streaming processor 120 transmits the set of pairs of sub-scaled images and a second subset of the pairs of the full-frame images over output communication interface 111, the second subset of the pairs of the full-frame images remaining unscaled.

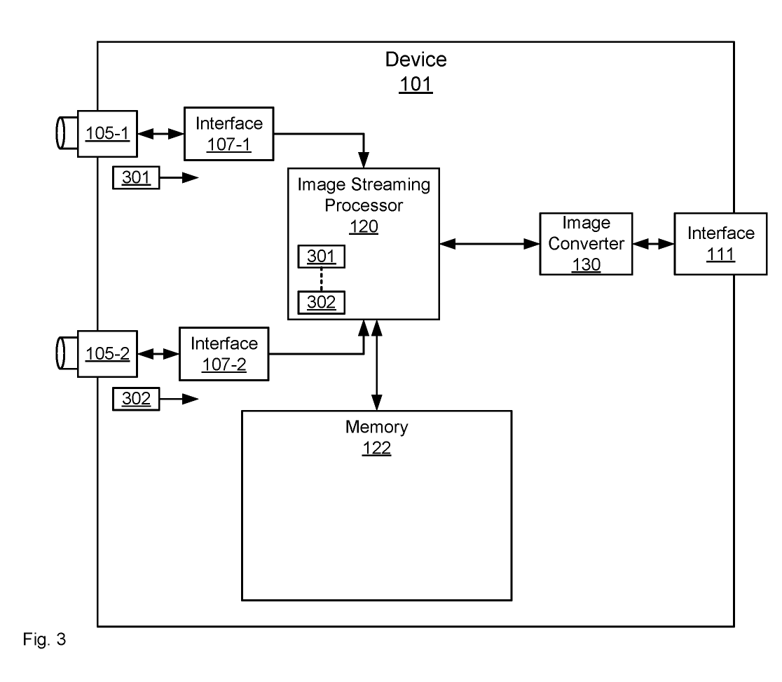

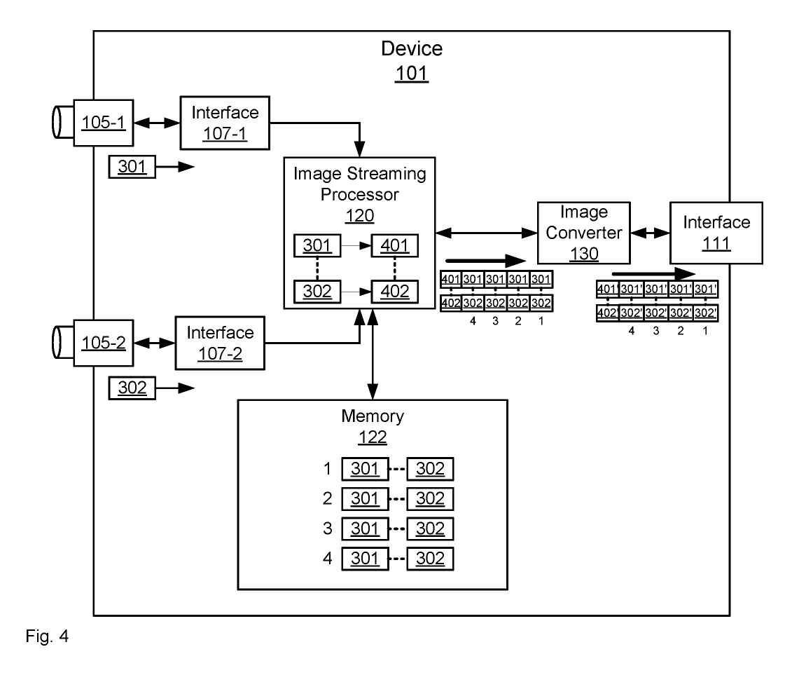

Method 200 will now be discussed with reference to FIGS. 3 to 4, each of which is substantially similar to FIG. 1, with like elements having like numbers.

Attention is hence next directed to FIG. 3 which depicts a non-limiting implementation of blocks 201, 203, in which image streaming processor 120 receives full-frame images 301, 302, respectively from each of first camera device 105-1 and second camera device 105-2 using one or more camera communication interfaces 107. While only one full-frame image 301, 302 from each of cameras 105 is depicted, it is assumed that full-frame images 301, 302 represent a stream of full-frame images from cameras 105 and/or a plurality of full-frame images from cameras 105, for example provided as video from cameras 105.

Furthermore, image streaming processor 120 synchronizes full-frame images 301, 302 in pairs, as indicated by the stippled line between full-frame images 301, 302 at image streaming processor 120. For example, image streaming processor 120 can determine one or more of when each of full-frame images 301, 302 were acquired and when each of full-frame images 301, 302 were received at image streaming processor 120; Hence image streaming processor 120 can synchronize full-frame images 301, 302 according a time of acquisition and/or a time of receipt.

Attention is next directed to FIG. 4, which depicts a non-limiting implementation of block 205, in which image streaming processor 120 scales a first subset of the pairs of the full-frame images 301, 302 to produce a set of pairs of sub-scaled images 401, 402. For example, the set of pairs of sub-scaled images 401, 402 can be produced by one or more of reducing a size and reducing a resolution of the first subset of the pairs of the full-frame images 301, 302. In other words, image streaming processor 120 can reduce a resolution of full-frame images 301, 302 to produce sub-scaled images 401, 402.

However, in other implementations, such sub-scaling at block 205 can include cropping each of the full-frame images 301, 302 in the first subset to reduce the size thereof. In these implementations, rather than reduce a resolution of the full-frame images 301, 302 in the first subset, a sub-set of each can be selected using cropping techniques, for example to select an area of each of the full-frame images 301, 302 that includes items to be analyzed and/or dimensioned. As such, the set of pairs of sub-scaled images 401, 402 each of a similar resolution as the corresponding full-frame images 301, 302, but are of a smaller size due to the cropping.

As further depicted in FIG. 4, image streaming processor 120 can be further configured to store at least a second subset of the pairs of the full-frame images 301, 302 in memory 122 (and/or a cache and/or a buffer) prior to transmitting the set of pairs of sub-scaled images 401, 402 and the second subset of the pairs of the full-frame images 301, 302 over the output communication interface 111. For example, second subset of the pairs of the full-frame images 301, 302 are stored in memory 122 and retrieved therefrom to combine with sub-scaled images 401, 402 once sub-scaled images 401, 402 are produced.

For example, as depicted, while image streaming processor 120 is producing sub-scaled images 401, 402, image streaming processor 120 also caches a second subset of the pairs of the full-frame images 301, 302 at memory 122, and specifically four pairs of full-frame images 301, 302, as indicated by “1”, “2”, “3”, “4”, however such numbering is not necessarily present in memory 122. However, image streaming processor 120 can be configured to maintain a record of an order of full-frame images 301, 302.

Image streaming processor 120 can be further configured to dynamically select which full-frame images 301, 302 from cameras 105 are stored in memory 122 and which full-frame images 301, 302 are selected for sub-scaling to produce sub-scaled images 401, 402. For example, a first given number of full-frame images 301, 302 can be selected for sub-scaling to produce sub-scaled images 401, 402 (e.g. the first given number of full-frame images 301, 302 comprises the number of images in the first subset of full-frame images 301, 302 selected in block 205), and a second given number of full-frame images 301, 302 can be selected for storage in memory 122 (e.g. the second given number of full-frame images 301, 302 comprises the number of images in the second subset of full-frame images 301, 302 that remain unscaled in block 207). In some implementations for every thirty-two pairs of full-frame images 301, 302 selected for sub-scaling to produce sub-scaled images 401, 402, four pairs of full-frame images 301, 302 can be selected for storage in memory 122, Such selection can occur in any order. A further number of full-frame images 301, 302 from cameras 105 can be discarded. In general, the number of images 301, 302 selected for each of sub-scaling and storage can depend on a maximum frame rate of interface 111, as described in further detail below.

FIG. 4 further depicts a non-limiting implementation of block 207, in which image streaming processor 120 transmits the set of pairs of sub-scaled images 401, 402 and a second subset of the pairs of the full-frame images 301, 302 over output communication interface 111, the second subset of the pairs of the full-frame images 301, 302 remaining unscaled. For example, once the set of pairs of sub-scaled images 401, 402 are produced, the second subset of the pairs of the full-frame images 301, 302 are retrieved from memory 122 and combined therewith.

In particular, as depicted, the set of pairs of sub-scaled images 401, 402 and a second subset of the pairs of the full-frame images 301, 302 are first received at image converter 130 which converts the set of pairs of sub-scaled images 401, 402 and a second subset of the pairs of the full-frame images 301, 302 to an output data format, as indicated by sub-scaled images 401′, 402′, and full-frame images 301′, 302′ being transmitted over interface 111. For example, image converter 130 can separate each full-frame image 301, 302 in the second subset of the pairs of the full-frame images 301, 302 into sub-portions of a size compatible with a protocol of output communication interface 111, and the sub-portions are transmitted sequentially over interface 111. Alternatively, such functionality can be integrated into image streaming processor 120.

Furthermore while a format of sub-scaled images 401′, 402′ can be different from a format of sub-scaled images 401, 402, in other implementations sub-scaled images 401, 402 are not reformatted as they can already be in a format suitable for transmission over interface 111; hence, in these implementations, image converter 130 combines and/or interleaves sub-scaled images 401, 402 with portions of second subset of the pairs of the full-frame images 301, 302 in the output data format.

For example, as interface 111 generally as limited bandwidth, each of full-frame images 301, 302 transmitted over interface 111 can divided into portions and/or sections of a size compatible with transmission over interface 111 and transmit the portions in a serial data stream over interface 111.

Either way, image streaming processor 120 can be further configured to transmit the set of pairs of sub-scaled images 401, 402 and the second subset of the pairs of the full-frame images 301, 302 over the output communication interface by interleaving the pairs of sub-scaled images 401, 402 and the second subset of the pairs of the full-frame images 301, 302 (and/or interleaving the pairs of sub-scaled images 401′, 402′ with the sub-portions of the second subset of the pairs of the full-frame images 301, 302 in a serial data stream).

In particular, sub-scaled images 401, 402 can be transmitted at a rate compatible with a live-image preview feature, for example at least 16 fps. Furthermore, a size of sub-scaled images 401, 402 can be of a size configured to achieve such a frame rate. For example, in some implementations, each of cameras 105 can have a resolution of 1280×960, or 1.2 Mp, with each pixel being a 12 bit pixel, such that each full-frame image pair 301, 302 has a size of about 28.8 Mb (e.g. 2×1.2 Mp×12 bits); to achieve a 16 fps transmission rate of sub-scaled images 401, 402, each sub-scaled image 401, 402 can comprise a QVGA (quarter VGA (video graphics array)) resolution which results in size of about 1.8 Mb, or 1/16 the size of the camera resolution. Furthermore, in specific implementations, for every thirty-two (32) pairs of sub-scaled images 401, 402, four (4) pairs of full-frame images 301, 302 can be transmitted over a USB interface. Furthermore, in these implementations, each of full-frame images 301, 302 can be divided into sixteen (16) sub-portions by image converter 130, each of a size of about 1.8 Mb (e.g. a QVGA size) and transmitted over interface 111. However, in these implementations, sub-scaled images 401, 402 are not divided into portions as their scaled size is already compatible with the USB protocol of interface 111. In these implementations, about 192 QGVA frames-per-second (fps) are transmitted over interface 111.

In implementations depicted herein, a size of each of sub-portions of full-frame images 301, 302 and sub-scaled images 401, 402 transmitted over interface 111 is a same size; however in other implementations, one or more of sub-portions of full-frame images 301, 302 and sub-scaled images 401, 402 transmitted over interface 111 can be different sizes.

Regardless, a size of sub-scaled images 401, 402 is selected to be at a frame rate over interface 111 that is compatible with a live-preview feature at a host device; furthermore, the size of sub-scaled images 401, 402 is selected so that the frame rate is less than a maximum and/or a functional maximum frame rate that can be transmitted over interface 111, when at least one pair of full-frame images 301, 302 is transmitted for each of a given set of pairs of sub-scaled images 401, 402 transmitted at a minimum frame rate for the live-preview feature at a host device. For example, when the minimum frame rate of sub-scaled images 401, 402 for the live preview feature is FRminss, and the maximum frame rate that can be transmitted over interface 111 is FRmax, and the frame rate for transmitting at least one pair of full-frame images 301, 302 is FRff (including a frame rate of transmitting sub-portions thereof), then a size of sub-scaled images 401, 402 is selected such that FRminss+FRff is less than or equal to FRmax.

Attention is next directed to FIG. 5 which depicts a side perspective view 5-I, a rear perspective view 5-II and a front perspective view 5-III of device 101 mated with a host device 501 (interchangeably referred to hereafter as device 501). Side perspective view 5-I further depicts a physical configuration of interface 111 mated with a respective communication interface 511 (interchangeably referred to hereafter as interface 511) of device 501.

In view 5-I, each of interfaces 111, 511 are depicted in stippled lines to indicate that each of interfaces 111, 511 are interior to host device 501. In particular, in some implementations, interface 111 can comprise a male USB port extending from device 101 on a side opposite cameras 105, and interface 511 can comprise a female USB port at a rear of device 501 into which interface 111 is inserted. Regardless, interfaces 111, 511 are communicatively mated. In depicted implementations, interfaces 111, 511 are also physically mated; in particular, as depicted, interface 511 is located on a rear of host device 501 and device 101 can “plug into” host device 501 via interfaces 111, 511 at a rear of host device 501 such that devices 101, 501 are provided in a compact, hand-held configuration and/or hand-held package. While not depicted, in some implementations devices 101, 501 can further comprise one or more fasteners, latches, clips and the like to physically (and removably) couple devices 101, 501 to each other.

However, in other implementations, devices 101, 501 can be in communication via a wireless and/or wired link between interfaces 111, 511. For example, when interfaces 111, 511 comprise USB interfaces, a link there between can comprise a USB cable; in some of these implementations, interface 511 can be located at a position on device 501 where is inconvenient to directly mate interfaces 111, 511 and hence communicative mating of interfaces 111, 511 can be implemented using a USB cable and the like.

However, in other implementations, interfaces 111, 511 can be wireless and a link there between can comprise, for example a Bluetooth™ link. However, other wired and wireless link and/or protocols and/or interface types are within the scope of present implementations.

As best seen in view 5-II, cameras 105 have a field of view facing a rear of host device 501. Furthermore cameras 105 can comprise a left camera and a right camera from a perspective of a user viewing a front of host device 501.

Furthermore, as depicted in view 5-III, host device 501 comprises a display device 516 which can provide a rendering of a live-image preview of items in a field of view of cameras 105 using at least a subset of the pairs of sub-scaled images 401, 402, as described below.

In particular, device 501 is configured to: receive the set of pairs of sub-scaled images 401, 402 and the second subset of the pairs of the full-frame images 301, 302 over respective communication interface 511, from output communication interface 111; render at least a subset of the set of pairs of sub-scaled images 401, 402 at display device 516; and, process the second subset of the pairs of the full-frame images 301, 302 to determine dimensions of items represented in the second subset of the pairs of the full-frame images 301, 302. When sub-scaled images 401′, 402′, and/or full-frame images 301′, 302′ are received in the output data format compatible with interface 111 (and/or interface 511) device 501 can further convert sub-scaled images 401′, 402′, and/or full-frame images 301′, 302′ to corresponding sub-scaled images 401, 402, and full-frame images 301, 302.

While a specific physical configuration of device 501 is depicted in FIG. 5, other physical configurations of device 501 are within the scope of present implementations. For example, device 501 can further include one or more input devices (including, but not limited to a physical and/or virtual keyboard), an RFID (radio frequency identification) and/or Near Field Communication (NFC) reader, one or more handles, a trigger for triggering the RFID and/or NFC reader and the like. In particular, device 501 can be configured for warehouse functionality and/or device 501 can comprise a data acquisition device.

Attention is next directed to FIG. 6 which is substantially similar to FIG. 4, with like elements having like numbers, however FIG. 6 further depicts a schematic block diagram of host device 501 in communication with device 101 via interfaces 111, 511. In particular, host device 501 comprises: respective communication interface 111, at least communicatively mated with output communication interface 511; display device 516; and an image processor 520 which implements functionality of host device 501 related to a live-image preview feature and image analysis including, but not limited to, dimensioning of items in a field of view of cameras 105. As depicted, device 501 further comprises a memory 522.

Hence, device 501 can comprise a computing device, including but not limited to a graphics processing unit (GPU), a graphics processing device, a graphics processing engine, a video processing device, and the like. In particular, device 501 can comprise an apparatus that can be interfaced and/or mated with device 101 using interface 511, to convert host device 501 into a live-image preview and image analysis device. As described above, device 501 can be specifically configured for warehouse functionality, though device 501 can be configured for other types of specialized functionality, including, but not limited to, one or more of mobile communication, mobile computing, entertainment, and the like.

Image processor 520 can comprise a processor and/or a plurality of processors, including but not limited to one or more central processors (CPUs) and/or one or more processing units and/or one or more graphic processing units (GPUs); either way, image processor 520 comprises a hardware element and/or a hardware processor. Indeed, in some implementations, image processor 520 can comprise an ASIC (application-specific integrated circuit) and/or an FPGA (field-programmable gate array) specifically configured to implement the functionality of device 501. Hence, device 501 is not necessarily a generic computing device, but a device specifically configured to implement specific functionality as described in further detail below. For example, device 501 and/or image processor 520 are specifically configured as an engine providing simultaneous live-image preview functionality and image analysis.

Memory 522 can comprise a non-volatile storage unit (e.g. Erasable Electronic Programmable Read Only Memory (“EEPROM”), Flash Memory) and a volatile storage unit (e.g. random access memory (“RAM”)). Programming instructions that implement the functional teachings of device 501 as described herein are typically maintained, persistently, in memory 522 and used by image processor 520 which makes appropriate utilization of volatile storage during the execution of such programming instructions. Those skilled in the art recognize that memory 522 is an example of computer readable media that can store programming instructions executable on image processor 520. Furthermore, memory 522 is also an example of a memory unit and/or memory module and/or a non-volatile memory.

In particular, memory 522 can store an application (not depicted) that, when implemented by image processor 520, enables image processor 520 to: receive the set of pairs of sub-scaled images 401, 402 and the second subset of the pairs of the full-frame images 301, 302 over respective communication interface 511, from output communication interface 111; render at least a subset of the set of pairs of sub-scaled images 401, 402 at display device 516; and, process the second subset of the pairs of the full-frame images 301, 302 to determine dimensions of items represented in the second subset of the pairs of the full-frame images 301, 302. Image processor 520 can be further configured to convert sub-scaled images 401′, 402′, and/or full-frame images 301′, 302′ to corresponding sub-scaled images 401, 402, and/or full-frame images 301, 302.

Image processor 520 is hence further configured to communicate with each of interface 511 and display device 516, which comprises any suitable one of, or combination of, flat panel displays (e.g. LCD (liquid crystal display), plasma displays, OLED (organic light emitting diode) displays, capacitive or resistive touchscreens, CRTs (cathode ray tubes) and the like.

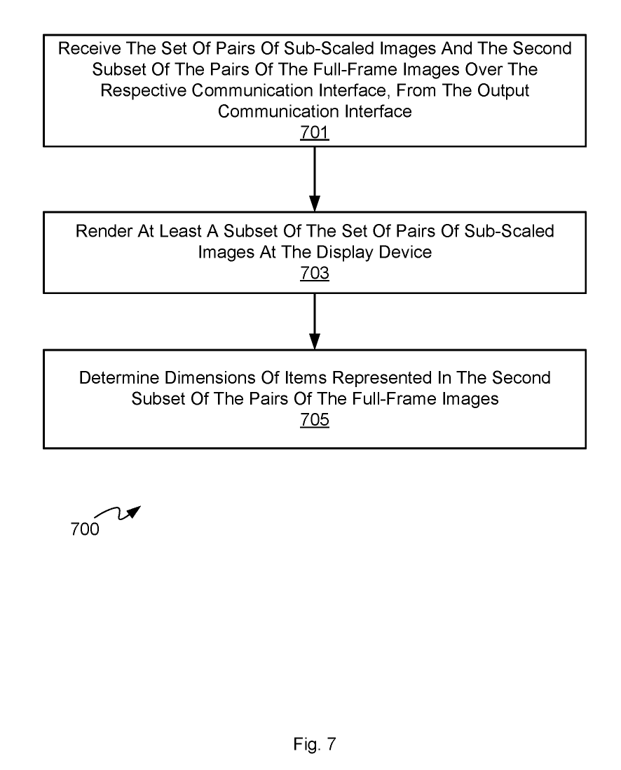

Attention is now directed to FIG. 7 which depicts a block diagram of a flowchart of a method 700 for transmitting full-frame images and sub-sampled images over a communication interface, according to non-limiting implementations. In order to assist in the explanation of method 700, it will be assumed that method 700 is performed using device 501, and specifically by image streaming processor 120 and when image processor 520 processes instructions stored at memory 522. Indeed, method 700 is one way in which device 501 can be configured. Furthermore, the following discussion of method 700 will lead to a further understanding of device 501, and its various components. However, it is to be understood that device 501 and/or method 700 can be varied, and need not work exactly as discussed herein in conjunction with each other, and that such variations are within the scope of present implementations.

Regardless, it is to be emphasized, that method 700 need not be performed in the exact sequence as shown, unless otherwise indicated; and likewise various blocks may be performed in parallel rather than in sequence; hence the elements of method 700 are referred to herein as “blocks” rather than “steps”. It is also to be understood, however, that method 700 can be implemented on variations of device 501 as well.

At block 701, image processor 520 receives the set of pairs of sub-scaled images 401, 402 (and/or sub-scaled images 401′, 402′) and the second subset of the pairs of the full-frame images 301, 302 (and/or full-frame images 301′, 302′) over respective communication interface 511, from output communication interface 111. At block 703, image processor 520 renders at least a subset of the set of pairs of sub-scaled images 401, 402 at display device 516. At block 703, image processor 520 processes the second subset of the pairs of the full-frame images 301, 302 to determine dimensions of items represented in the second subset of the pairs of the full-frame images 301, 302. At any of blocks 701, 703, 705 image processor 520 can further \ convert sub-scaled images 401′, 402′, and full-frame images 301′, 302′ to corresponding sub-scaled images 401, 402, and full-frame images 301, 302.

Hence, in general, device 501 separates sub-scaled images 401, 402 from full-frame images 301, 302, analyzes full-frame images 301, 302, and renders at least a subset of sub-scaled images 401, 402 at display device 516. As sub-scaled images 401, 402 comprise stereo images of items in a field of view of cameras 105, sub-scaled images 401 can be rendered at display device 516, sub-scaled images 402 can be rendered at display device 516, and/or when display device 516 is configured to render stereo images, both of sub-scaled images 401, 402 can be rendered at display device 516.

Attention is next directed to FIG. 8 which depicts a specific non-limiting implementation of a device 801 for transmitting full-frame images and sub-sampled images over a communication interface; device 801 is substantially similar to device 101 with like elements having like numbers, however in an “800” series rather than a “100” series. Hence, device 801 comprises two cameras 805-1, 805-2 (interchangeably referred to hereafter as cameras 805), one or more camera interfaces 807-1, 807-2 (interchangeably referred to hereafter as interfaces 807), a memory 822, an output communication interface 111 and an image converter 830. While an image streaming processor, similar to image streaming processor 120, is not depicted, it is appreciated that functionality of image streaming processor 120 can be implemented in a frame synchronization frame buffer 810 (which can also be at least partially implemented with memory 822), scaling engines 815, a memory controller 819 and a formatter 823.

Furthermore, it is assumed in FIG. 8 that device 801 can have a physical configuration similar to that of device 101 depicted in FIG. 5 and hence cameras 805 can comprise a left camera and a right camera which in turn acquire left full-frame images and right full-frame images, respectively referred to in FIG. 8 as “ff Left” and “ff Right”. Similarly, left sub-scaled images and right sub-scaled images are respectively referred to in FIG. 8 as “ss Left” and “ss Right”.

In any event, left and right full-frame images are acquired by cameras 805 and received at frame synchronization frame buffer 810 where they are synchronized, for example at blocks 201, 203 of method 200 as described above, to produce pairs of full-frame images (e.g. a left full-frame image is paired with a right full-frame image). Frame synchronization frame buffer 810 provides first subset of pairs of full-frame images to scaling engines 815, for example left full-frame images to a first scaling engine 815 and right full-frame images to a second scaling engine 815; while two scaling engines 815 are depicted, which can scale full-frame images in parallel, in some implementations device 801 comprises only one scaling engine 815. Regardless, one or more scaling engines 815 are configured to produce a respective sub-scaled image in pairs (e.g. a sub-scaled left image and a sub-scaled right image), for example a set of pairs of sub-scaled images (e.g. at block 205 of method 200). As such, one or more scaling engines 815 can comprise one or more scaling processors.

Frame synchronization frame buffer 810 further provides a second subset of pairs of full-frame images (labelled ff(L+R)) to memory controller 819, which caches the second subset of pairs of full-frame images at memory 822 while scaling engines 815 scale the first subset of pairs of full-frame images; as depicted, four full-frame images are cached at memory 822, labelled “1”, “2”, “3”, “4”.

Once scaling engines 815 produce a set of pairs of sub-scaled images, the set of pairs of sub-scaled images are provided to formatter 823. Similarly, once scaling engines 815 produce the set of pairs of sub-scaled images, memory controller 819 retrieves the cached second subset of pairs of full-frame images from memory 822 and provides them to formatter 823. Formatter 823 combines the set of pairs of sub-scaled images and the second subset of pairs of full-frame images and provides them to image converter 830, which in turn converts them to a format compatible with interface 811 (e.g. a USB compatible format). The converted pairs of sub-scaled images and full-frame images are transmitted to a host device (not depicted but similar to device 501) via interface 811 (e.g. at block 207 of method 200).

In some implementations, image converter 830 can comprise a USB2 controller chip including, but not limited to, a Cypress™ FX3 USB2 chip. However, in other implementations, image converter 830 can comprise a USB chip for USB controller chip and/or a USB3 controller chip. Either way, a format of image converter 830 can be selected for compatibility with connector and/or interface of a host device (e.g. interface 511 of host device 501). Hence, as depicted, data links compatible with such a controller chip are depicted between formatter 823 and image converter 830. Such data links include an IC2 data link over which IC2 commands can be passed to device 801, which can include commands for controlling cameras 805 implemented at a device 808 (e.g. an IC2 interface, which control various functionality of cameras 805 via an IC2 protocol, including, but not limited to, auto exposure of cameras 805; however, functionality of device 808 can be incorporated into interfaces 807). Data links between formatter 823 and image converter 830 can further include D0, D11, D12, and D23 data links, one of which can provide left images (both sub-scaled images and full-frame images) to image converter 830, another of which can provide right images (both sub-scaled images and full-frame images) to image converter 830. Such data links between formatter 823 and image converter 830 can further include an HSYNC data link (used to indicate that a line of an image frame has been transmitted), a VSYNC data link (used to indicate that an entire image frame has been transmitted) and a PCLK (pixel clock) data link (to synchronize image timing).

In some implementations, each scaling engine 815 scales a full-frame image to 1/16 of its original resolution (e.g. the resolution of cameras 805), however such scaling can be adjustable, for example to increase or decrease a frame rate over interface 811.

As described above, in particular non-limiting implementations each camera 805 has a resolution of 1280×960 or 1.2 Mp, and full-frame images are scaled to 1/16 this size at scaling engines 815 to a QVGA format. As such, in these implementations, 32 sub-scaled left preview QVGA images, 32 sub-scaled right preview QVGA images, 4 full-frame left images and 4 full-frame right images can be transmitted over interface 811 at a frame rate of 192 QVGA fps, assuming that each full-frame image is, in turn, divided into 16 QVGA sized portions and/or pieces and/or sections. As the maximum frame rate over a USB interface is 217 QVGA fps, live-image preview images and full-frame images for analysis (including dimensioning analysis) can be transmitted over interface 811 a frame rate less than a maximum frame rate of a USB interface.

Attention is next directed to FIG. 9, which depicts a non-limiting example, of part of a stream 901 of image portions transmitted over interface 811 as produced by image converter 830, as function of time. In particular, each full-frame image is divided into 16 portions, and each sub-scaled image is 1/16 a size of a full-frame image. Hence, stream 901 comprises a sub-scaled left image ( 1/16 its original size), a sub-scaled right image ( 1/16 its original size), a first portion of a full-frame left image (provided as a first portion F1 comprising 1/16 of the full-frame left image), a first portion of a full-frame right image (provided as a first portion F1 comprising 1/16 of the full-frame right image), a second portion of a full-frame left image (provided as a second portion F2 comprising 1/16 of the full-frame left image, and different from the first portion F1), a second portion of a full-frame right image (provided as a second portion F2 comprising 1/16 of the full-frame right image, and different from the first portion F1), and so on. While not depicted, it is assumed that stream 901 of image portions further comprises the remaining portions of each of the full-frame left image and the full-frame right image. It is further assumed that thirty-two pairs of sub-scaled images are provided for every four pairs of full-frame images in stream 901. Furthermore, while stream 901 depicts a particular format for streaming portions of images, other formats are within the scope of present implementations; for example, stream 901 can comprise a 24 bit data stream divided into sections for left image pixels (e.g. bits 0-11) and right image pixels (e.g. bits 12-23), or vice-versa, and furthermore, each image and/or image portion can be transmitted and/or streamed, serially, line by line. Furthermore, while portions F1, F2 of left full-frame images and right full-frame images are interlaced with left sub-scaled images and right sub-scaled images in a particular depicted format, other formats are within the scope of present implementations, as long as host device 501 is configured for processing the transmitted format of stream 901.

In any event, as, in depicted implementations, thirty-two pairs of sub-scaled images are transmitted for every four pairs of full-frame images, and as each full-frame image is 16 times a size of a sub-scaled image, in a time period where the thirty-two pairs of sub-scaled images and four pairs of full-frame images are transmitted, ⅓ of the time period is used to transmit sub-scaled images, and ⅔ of the time period is used to transmit full-frame images (e.g. 32 sub-scaled images for every 64 sub-portions of full-frame images). While present implementations are described with respect to dividing full-frame images into 16 portions, and furthermore scaling full-frame images to 1/16 their original size to produce sub-scaled images, other numbers of portions, and other scaling size are within the scope of present implementations; indeed, a number of portions and a scaling size can be selected for compatibility with an interface over which the sub-scaled images and the full-frame images are to be transmitted.

Regardless, formatting full-frame images and sub-scaled images as described herein can address the technical problem of transmitting enough images over a USB interface, of a sufficient resolution, for both a live-image preview and image analysis, including, but not limited to, dimensioning of items in the full-frame stereo images. In other words, a sub-scaled images at least at a frame rate compatible with a live-preview function at a host device, and that is less than a maximum frame rate of the interface so allow for full-frame images to also be transmitted, for example in a serial data stream.

Further provided herein is a device for adapting a host device, which can include a mobile device, for live-previewing of items using sub-scaled images, as well as analysis of the items in corresponding full-frame images.

In the foregoing specification, specific implementations have been described. However, one of ordinary skill in the art appreciates that various modifications and changes can be made without departing from the scope of the specification as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting implementation the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some implementations may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an implementation can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

We claim:

1. A device comprising:
a first camera device and a second camera device; one or more camera communication interfaces in communication with the first camera device and the second camera device; an output communication interface; and,
an image streaming processor configured to:
receive full-frame images from each of the first camera device and the second camera device using the one or more camera communication interfaces;
synchronize the full-frame images in pairs;
scale a first subset of the pairs of the full-frame images to produce a set of pairs of sub-scaled images; and,
transmit the set of pairs of sub-scaled images and a second subset of the pairs of the full-frame images over the output communication interface, the second subset of the pairs of the full-frame images remaining unscaled.

2. The device of claim 1, further comprising a memory and the image streaming processor is further configured to store at least the second subset of the pairs of the full-frame images in the memory prior to transmitting the set of pairs of sub-scaled images and the second subset of the pairs of the full-frame images over the output communication interface.

3. The device of claim 1, further comprising an image converter configured to convert the set of pairs of sub-scaled images and the second subset of the pairs of the full-frame images to an output data format prior to transmitting the set of pairs of sub-scaled images and the second subset of the pairs of the full-frame images over the output communication interface.

4. The device of claim 1, wherein a bandwidth of the output communication interface is less than a bandwidth supporting a frame rate corresponding to a live preview of the full-frame images from each of the first camera device and the second camera device.

5. The device of claim 4, wherein the output communication interface comprises a Universal Serial Bus interface.

6. The device of claim 1, wherein the image streaming processor is further configured to scale the first subset of the pairs of the full-frame images to produce the set of pairs of sub-scaled images by one or more of reducing a size and reducing a resolution of the first subset of the pairs of the full-frame images.

7. The device of claim 1, wherein the image streaming processor is further configured to transmit the set of pairs of sub-scaled images and the second subset of the pairs of the full-frame images over the output communication interface by interleaving the pairs of sub-scaled images and the second subset of the pairs of the full-frame images.

8. The device of claim 1, wherein the image streaming processor is further configured to transmit the set of pairs of sub-scaled images and the second subset of the pairs of the full-frame images over the output communication interface by:
separating each full-frame image in the second subset of the pairs of the full-frame images into sub-portions of a size compatible with a protocol of the output communication interface; and,
interleaving the pairs of sub-scaled images with the sub-portions of the second subset of the pairs of the full-frame images in a serial data stream.

9. The device of claim 1, wherein paired full-frame images from each of the first camera device and the second camera device comprise stereo images.

10. The device of claim 1, further comprising a host device comprising: a respective communication interface, physically and communicatively mated with the output communication interface; a display device; and an image processor configured to:
receive the set of pairs of sub-scaled images and the second subset of the pairs of the full-frame images over the respective communication interface, from the output communication interface;
render at least a subset of the set of pairs of sub-scaled images at the display device; and,
process the second subset of the pairs of the full-frame images to determine dimensions of items represented in the second subset of the pairs of the full-frame images.

11. A method comprising:
at a device comprising: a first camera device and a second camera device; one or more camera communication interfaces in communication with the first camera device and the second camera device; an output communication interface; and, an image streaming processor, receiving, at the image streaming processor, full-frame images from each of the first camera device and the second camera device using the one or more camera communication interfaces;
synchronizing, at the image streaming processor, the full-frame images in pairs;
scaling, at the image streaming processor, a first subset of the pairs of the full-frame images to produce a set of pairs of sub-scaled images; and,
transmitting, using the image streaming processor, the set of pairs of sub-scaled images and a second subset of the pairs of the full-frame images over the output communication interface, the second subset of the pairs of the full-frame images remaining unscaled.

12. The method of claim 11, wherein the device further comprises a memory, and method further comprises storing, using image streaming processor, at least the second subset of the pairs of the full-frame images in the memory prior to transmitting the set of pairs of sub-scaled images and the second subset of the pairs of the full-frame images over the output communication interface.

13. The method of claim 11, wherein the device further comprises an image converter, and the method further comprises converting, using the image converter, the set of pairs of sub-scaled images and the second subset of the pairs of the full-frame images to an output data format prior to transmitting the set of pairs of sub-scaled images and the second subset of the pairs of the full-frame images over the output communication interface.

14. The method of claim 11, wherein a bandwidth of the output communication interface is less than a bandwidth supporting a frame rate corresponding to a live preview of the full-frame images from each of the first camera device and the second camera device.

15. The method of claim 11, further comprising scaling, using the image streaming processor, the first subset of the pairs of the full-frame images to produce the set of pairs of sub-scaled images by one or more of reducing a size and reducing a resolution of the first subset of the pairs of the full-frame images.

16. The method of claim 11, further comprising transmitting, using the image streaming processor, the set of pairs of sub-scaled images and the second subset of the pairs of the full-frame images over the output communication interface by interleaving the pairs of sub-scaled images and the second subset of the pairs of the full-frame images.

17. The method of claim 11, further comprising transmitting, using the image streaming processor, the set of pairs of sub-scaled images and the second subset of the pairs of the full-frame images over the output communication interface by:
separating each full-frame image in the second subset of the pairs of the full-frame images into sub-portions of a size compatible with a protocol of the output communication interface; and,
interleaving the pairs of sub-scaled images with the sub-portions of the second subset of the pairs of the full-frame images in a serial data stream.

18. The method of claim 11, wherein paired full-frame images from each of the first camera device and the second camera device comprise stereo images.

19. The method of claim 11, wherein the device further comprises a host device comprising: a respective communication interface, physically and communicatively mated with the output communication interface; a display device; and an image processor, and the method further comprises:
receiving, at the image processor, the set of pairs of sub-scaled images and the second subset of the pairs of the full-frame images over the respective communication interface, from the output communication interface;
rendering, at the image processor, at least a subset of the set of pairs of sub-scaled images at the display device; and,
processing, at the image processor, the second subset of the pairs of the full-frame images to determine dimensions of items represented in the second subset of the pairs of the full-frame images.

20. A non-transitory computer-readable medium storing a computer program, wherein execution of the computer program is for:
at a device comprising: a first camera device and a second camera device; one or more camera communication interfaces in communication with the first camera device and the second camera device; an output communication interface; and, an image streaming processor, receiving, at the image streaming processor, full-frame images from each of the first camera device and the second camera device using the one or more camera communication interfaces;
synchronizing, at the image streaming processor, the full-frame images in pairs;
scaling, at the image streaming processor, a first subset of the pairs of the full-frame images to produce a set of pairs of sub-scaled images; and,
transmitting, using the image streaming processor, the set of pairs of sub-scaled images and a second subset of the pairs of the full-frame images over the output communication interface, the second subset of the pairs of the full-frame images remaining unscaled.
